(19) United States
(12) Patent Application Publication
(10) Pub. No.: US 2012/0212455 A1
(43) Pub. Date: Aug. 23, 2012

(54) TECHNICAL MEDICAL DEVICE HAVING A MULTIFUNCTION DISPLAY

(76) Inventor: Peter KLOEFFEL, Nuedlingen (DE)

(21) Appl. No.: 13/399,323

(22) Filed: Feb. 17, 2012

Related U.S. Application Data
(60) Provisional application No. 61/444,329, filed on Feb. 18, 2011.

(30) Foreign Application Priority Data
Feb. 18, 2011 (DE) 10 2011 011 767.9

(51) Int. Cl. G06F 3/042; G09G 3/36; G06F 3/045

(52) U.S. Cl. 345/175; 345/174

(57) ABSTRACT

The invention relates to the field of technical medical devices, for example, dialysis machines. The object of the invention is to improve upon a technical medical device in such a way that the structural complexity of the technical medical device, the assembly, cleaning and maintenance expense for the technical medical device and the cost of the technical medical device are reduced, but at the same time the variety of functions increases. The technical medical device according to the invention therefore comprises a screen, which can be equipped to function as a sound converter or as an optical sensor or as a receiver and sender of electromagnetic waves. In addition, a method is disclosed whereby the control of the technical medical device is influenced on the basis of the input and output of information via the inventive display screen.

The invention relates to a technical medical device having at least one display screen and a method for operating the technical medical device having at least one display screen.

Technical medical devices are often equipped with display screens such as LCD screens, TFT screens or OLED screens, which may be embodied with or without touchscreen functionality. In addition to displaying information, touchscreens also offer a convenient and variable input option for information by fingerprint operation by the user on the touchscreen surface and, due to the flat design, they also offer a surface, which is easy to clean and is therefore hygienic.

Technical medical devices are often equipped with a variety of other devices for information output and for information input. For example, acoustic signals are emitted by a loudspeaker. Optical sensors such as fingerprint scanners or cameras for input of documents held in front of the screen may also be parts of technical medical devices.

Each of these devices is an independent component with controlling and analyzing hardware. Therefore, furnishing the technical medical devices with equipment of the aforementioned type means a high assembly effort and complexity, high costs and a high maintenance complexity in the event of a defect. In addition, due to the use of separate components for the aforementioned devices, the surface of the technical medical device is often breached, which makes cleaning the surface difficult and may also have aesthetic disadvantages.

The object of the present invention is therefore to improve upon a generic medical device, so that it overcomes the disadvantages of the state of the art.

According to the teaching of the invention, this object is achieved by a technical medical device according to the preamble of Claims 1, 2 or 3 by the fact that the technical medical device has a display screen, which is designed to emit audio signals and to convert audio signals into electrical signals and/or to optically detect objects held in front of at least parts of its screen surface and/or to send and receive electromagnetic signals.

In addition, according to the teaching of the invention, this object is achieved by a method according to Claim 19, according to which a single module is used in a technical medical device for output and detection of optical, acoustic and/or electromagnetic signals.

Advantageous embodiments are the subject matter of the dependent claims.

Display screens for medical devices are embodied primarily as TFT-LCD (thin-film transistor liquid crystal displays) in the state of the art. These are a special embodiment of liquid crystal display screens, in which each pixel has its own controlling transistor on a glass carrier with an applied layer of amorphous silicon. This carrier extends over the entire surface of the display screen because each liquid crystal cell and/or each pixel is switched by a transistor spatially close to it. In this way, the plane of polarization of the liquid crystal cell is rotated, so that polarized light from a light source located behind the liquid crystal cell is either allowed to pass through or is blocked. Through appropriate control of the individual pixels, a graphical representation is formed for the user on the screen.

Amorphous silicon has comparatively poor semiconductor properties. It has relatively poor electron mobility which is determined by the numerous grain boundaries. When using polysilicon, the grain sizes are larger than with amorphous silicon, but nevertheless polysilicon also has poor semiconductor properties, which make integration of complex electronics difficult.

Recently TFT-LCDs using another form of silicon known as “continuous grain” silicon (CG-Si) have come on the market. This CG-Si comes relatively close in its properties to monocrystalline silicon. CG-Si has larger and more uniform crystals in comparison with amorphous silicon or polysilicon, so the electron mobility is up to 600 times greater than that in amorphous silicon. Due to the fact that the conductivity of integrated components is therefore improved, they can be dimensioned with much smaller dimensions while maintaining the same conductivity. CG-Si technology makes possible transistor sizes of 3 μm (minimal gate length of a field effect transistor) and the minimal transistor size will drop further due to the further development of the technology. Thus, when using CG-Si, complex electronic groups and sensors are also integrated on the carrier glass in addition to the control transistors for the liquid crystal cells. U.S. 2003151600A, for example, discloses such a display using continuous grain technology, where at least parts of a transceiver and at least parts of a system controller together with the controlling electronics of the liquid crystal cells of an LCD display are integrated on a substrate.

Display screens which contain other functionalities in addition to displaying optical information and/or the conventional touchscreen functionality are referred to below as multifunction displays. It does not matter here whether the multifunction display is based on CG-Si technology. It is important that the underlying technology makes possible the integration of additional electronic components on the same semiconductor layer on which the controlling components for controlling the image-generating devices are also integrated. These additional electronic components may be used for controlling a variety of other devices in addition to the image-generating devices. The image-generating devices include all devices that are used to display an image, for example, in the case of an LCD, the transistors which control the liquid crystal cells and all other necessary equipment, for example, driver circuits.

This opens up a variety of possible applications for technical medical devices.

A dialysis machine, which may be embodied as a hemodialysis machine or as a device for automatic peritoneal dialysis, shall be considered below as representative of a technical medical device. It will be clear to those skilled in the art that the present invention may be used with any technical medical device without any further assistance.

A dialysis machine is used to treat a person suffering from renal insufficiency. In this process, toxins and water are removed from the patient's blood by a technical method. One essential task of a person's kidneys is to separate substances that must be removed in the urine from the blood and to regulate the elimination of water and the electrolyte balance.

Hemodialysis is a treatment method for compensation of malfunctions.

In hemodialysis, blood is directed through the blood chamber of a dialyzer in an extracorporeal circulation, this blood chamber being separated from a dialysis fluid chamber by a semipermeable membrane. Dialysis fluid containing blood electrolytes in a certain concentration flows through this dialysis fluid chamber. The substance concentration in the dialysis fluid corresponds to the concentration in the blood of a healthy person. During the treatment, the patient's blood and the dialysis fluid are passed on both sides of the membrane, usually in countercurrent, at a predetermined flow rate. Substances that must be eliminated in the urine diffuse through the membrane from the blood chamber into the chamber for dialysis fluid, while at the same time electrolytes present in the blood and in the dialysis fluid diffuse from the chamber having the higher concentration to the chamber having the lower concentration. The metabolism may be influenced additionally by applying a transmembrane pressure.

In peritoneal dialysis, a patient's abdominal cavity is filled with a dialysis fluid through a catheter passed through the diaphragm. This dialysis fluid has a concentration gradient with respect to the endogenous fluids. The toxins present in the body enter the abdominal cavity through the peritoneum, which functions as a membrane. After a few hours, the spent dialysis fluid inside the patient is replaced. For at least partial automation of this process, special machines are used in practice, such as the Sleep-Safe machine from Fresenius Medical Care.

Touchscreen displays for display and input of information have long been the state of the art on equipment for performing hemodialysis or for automatic peritoneal dialysis. EP 0 623 357, for example, describes an apparatus and a method for dialysis, in which the interface between the machine and the user is implemented by such a touchscreen monitor.

Touchscreen displays may be equipped with a touch-sensitive layer, which, when touched, generates an electrical signal that can be allocated to the position of the touch in an analysis unit. In this way, the position of a fingerprint on the display screen can be ascertained.

Due to the additional touch-sensitive layer, a touchscreen is usually more expensive than a normal TFT-LCD. The CG-Si technology also makes it possible to integrate phototransistors on the glass carrier beneath each pixel. These act as optical sensors, in which incident light is converted into electrical signals. This makes it possible to scan objects on the display with pixel precision in the image technology. This property may be utilized, for example, to determine the position of a finger on the display screen and thus to simulate the functionality of a touchscreen, with the difference being that now no touch-sensitive layer on the display screen is necessary to do so.

In addition, objects may also be recognized with regard to their structure on the display screen, because the resolution of the imaging phototransistors corresponds to the resolution of the screen. With a screen resolution of 1200 pixels horizontally×800 pixels vertically over a screen surface area of 38 cm×30 cm, for example, this yields a resolution of the sensor device of approximately 80 dpi horizontally and 68 dpi vertically. This resolution is sufficient to enter barcodes, for example, or to recognize other patterns, which are designed accordingly.

A multifunction display designed in this way thus acts as an optical scanner. This yields certain advantages in conjunction with its use with a dialysis machine. Before the treatment, dialysis machines are equipped with disposables (disposable medical articles) such as dialysis filters, tubing sets or storage containers with dialysis-specific solutions or powders. These may be furnished with a barcode for their verification. Other graphic features, for example, coloration, are also conceivable. The dialysis machine is equipped with different disposables, depending on the type of treatment and the patient. For example, a distinction is made between dialysis filters for treatment of adults and dialysis filters for treatment of a child.

The data on the patient to be treated as well as the treatment arranged by the attending physician is usually disclosed for the dialysis machine. This is often done by manually by input of the treatment parameters. The touchscreen functionality of a multifunction display equipped in this way may be used here.

Alternatively, however, the patient may also have an individual patient card, which has a barcode, for example, for unambiguous identification of the patient. In a central computer, the parameters for the dialysis treatment currently set up may be stored for each dialysis treatment of that specific patient. The patient card may then be held in front of the display screen of the dialysis machine, which is designed as a multifunction display with a scanner functionality, so that the barcode can be input.

It is thus possible for the dialysis machine to be automatically set for the treatment through a data connection to a central computer in which the patient data and treatment data assigned to the barcode input are stored. Typical treatment parameters include, for example, the blood flow rate and the dialysis flow rate. In addition, the dialysis machine may also be informed of which disposables are to be used, for example, the dialysis filter to be used, in this way.

After recognizing the patient and the type of treatment, which may be indicated via the multifunction display, the set-up parts and/or disposables to be used as well as the type of set-up parts and how used may be displayed to the operating personnel setting up the dialysis machine. To make the set-up procedure safer and more convenient, the dialysis machine may also instruct the operator through corresponding optical display on the screen to hold the barcode of the set-up part needed at that time in front of the multifunction display. The barcode of the corresponding set-up part is then input and verification of whether the correct set-up part is present is obtained. If the set-up part in question is not appropriate for the selected treatment or if it is a set-up part without a barcode, the dialysis machine may refuse the treatment. It is possible in this way to prevent the wrong equipment from being used and/or to prevent the use of disposables of an uncertified manufacturer.

It is also conceivable for parts of the display screen not to be furnished with liquid crystal cells. More phototransistors per unit of area may be arranged in this area to increase the scanner resolution there. Even finely divided structures such as fingerprints can be scanned and recognized in this way.

A display screen embodied in this way thus additionally also acts as a high-resolution scanner, in particular as a fingerprint scanner on a partial area of the display screen surface. In conjunction with use with a dialysis machine, this yields additional advantages. These advantages include all the advantages of the combination of a dialysis machine as described above with a multifunction display having a scanner functionality because all the scanner functions also work with a higher resolution. In addition, due to the high resolution, fingerprints, for example, can be recognized. People associated with a dialysis treatment can thus be recognized on the basis of their fingerprints. For example, instead of the patient card used as described above, in this case the patient's fingerprint may be used for unambiguous identification. The operating personnel can also be recognized on the basis of their fingerprints. For example, the dialysis machine may be provided only for operator interventions by certain people (medical personnel). A person can thus be identified unambiguously by entering his fingerprint. Depending on whether or not the person thereby recognized is also allowed to operate the dialysis machine or is allowed to operate it only in part, the dialysis machine can allow the operating options, refuse them or allow only certain portions. It is also advantageous that it is possible to store, on the basis of the fingerprint, which person has selected which operating option. Persons not allowed, for operation of the dialysis machine, in other words, either unknown persons or known persons without operating rights, may be denied all operating options.

Through the scanner functionality of a multifunction display having a high resolution, so-called 2D product codes can also be recognized when used with a dialysis machine. These 2D product codes have finer structures than conventional barcodes and offer more possibilities for encoding the product properties.

It is also conceivable for a lens in front of such a high-resolution partial area of the screen to project the image of an object situated at a distance from the display onto the phototransistors. Objects or people who do not come in direct contact with the display can be detected and recognized through image technology in this way. It is also conceivable for the lens to be an automatically focusing lens, which is automatically adjusted sharply on the object in front of it through corresponding autofocusing devices with which those skilled in the art are familiar from photographic technology.

A display screen designed in this way thus also functions as a camera. In conjunction with its use with a dialysis machine, this also yields additional advantages. In addition, objects and people can be evaluated and recognized by a camera system through image technology. For example, it is conceivable for people to be recognized by the dialysis machine on the basis of their camera image alone and for suitable measures to be taken, as already explained above. Likewise, objects such as the disposables to be introduced may also be recognized on the basis of the camera image and corresponding measures (for example, refusal or enabling of treatment) to be initiated by the dialysis machine accordingly, as explained above. Furthermore, it is also conceivable not only for the person or object to be recognized on the basis of their camera images but also for additional properties of the person or the object beyond what is recognized by the corresponding camera image to be recognized. For example, the camera functionality of the multifunction display may conceivably also comprise the infrared emission by an object or a person to detect its surface temperature and/or body temperature.

Through the integration of complex electronics on the semiconducting layer of the glass carrier, a variety of other applications would also be conceivable. For example, analog and/or digital electronics, which are integrated into the semiconducting layer of the glass carrier, may be designed to control an electromagnetic converter.

An electromagnetic converter is, for example, a device which converts electrical signals into a mechanical movement or, conversely, converts mechanical movement into electrical signals. Those skilled in the art will be aware here of, for example, loudspeakers and microphones, actuators, for example, motors and sensors such as pressure sensors or fuel sensors.

The electronics also integrated into the glass carrier layer of a display screen may be designed for controlling loudspeakers and/or microphones, for example. Loudspeakers may also be used as microphones at the same time because sound acting on the diaphragm of a dynamic loudspeaker causes a movement of the diaphragm and thus a movement of the oscillating coil of the loudspeaker in a magnetic field, which generates an electrical signal proportional to the acoustic signal thereby in effect.

However, loudspeakers and/or microphones are also integral components of a multifunction display in order to further reduce the number of modules used.

This is possible through the present invention in that an additional piezoelectric layer, which may act as a single piezoelectric element or as multiple piezoelectric elements, is applied to the multifunction displays. Piezoelectric elements make use of the piezoelectric effect to execute a movement by applying an electrical voltage or to generate an electrical voltage by action of a force. Piezoelectric elements may thus be set up as sound converters, actuators and/or force sensors. Piezoelectric elements may be certain crystals (piezoelectric crystals) or piezoelectric ceramics, in other words, polycrystalline materials.

Light-permeable electrodes, preferably made of indium tin oxide (ITO), contact the top and bottom sides of a piezoelectric layer. A piezoelectric element is formed due to the intersection of the upper and lower electrodes with the piezoelectric layer in between.

With appropriate control, in which a voltage that is proportional to an audio signal is applied via the electrodes to a piezoelectric element, the piezoelectric element changes its extent in the direction of the electrodes in accordance with the applied electrical voltage. Sound is emitted in this way, the sound being louder, the larger the area of the piezoelectric element and the higher the controlling voltage, which is an a.c. voltage, when an audio signal is to be emitted.

The amplitude of the possible deformation of piezoelectric elements is comparatively small in comparison with that of dynamic loudspeakers, but because the emitting surface may cover the entire surface area of the screen, it may be much larger than that of the loudspeakers normally used, so the maximum loudness emitted may be adequate.

It is also possible to use all or part of the piezoelectric layer of the screen as a microphone. The piezoelectric effect by which an electrical voltage is generated on action of a force is utilized to convert sound into an electrical signal. A sound signal acting on a corresponding piezoelectric element induces a vibration proportional to the sound signal in that element, thereby forming an electrical signal, which is applied to the contacting electrodes and can be processed further by an electronic circuit also integrated into the semiconducting layer of the glass carrier of the display screen. When equipped in this way, the piezoelectric elements act as sound converters, which emit sound as well as being able to convert sound into electrical signals.

A multifunction display designed in this way thus acts as a loudspeaker and/or as a microphone. In conjunction with its use with a dialysis machine, this also yields additional advantages. The dialysis machine need no longer be equipped with separate loudspeakers or microphones and their controlling devices. This reduces the cost of assembly and maintenance and also permits simpler hygienic cleaning of the dialysis machine because the multifunction display with the loudspeaker and/or microphone functionality offers a smooth flat surface, whereas loudspeakers and microphones at least require small openings in the device surface in order to be effective.

If the loudspeaker functionality and the microphone functionality are combined with the camera functionality described above, which is possible at any time, and if the multifunction display is movably connected to the dialysis machine, then bidirectional optical and acoustic communication with the patient can be implemented.

The patient can thus pursue entertainment media content on the screen during the dialysis while at the same time the screen also serves as a loudspeaker for speech or music (for example, for playback of movies). Due to the camera functionality integrated into the multifunction display, the patient can also be monitored by the medical personnel in the manner described above. Furthermore, a microphone functionality integrated into the multifunction display may serve to allow the patient to communicate verbally with the medical personnel at a distance. This may be initiated by the patient himself, for example, if the patient depresses a call key, which is conveniently accessible to the patient, whereupon the medical personnel can talk to the patient via the loudspeaker integrated into the multifunction display and corresponding communication means, with which those skilled in the art are familiar, as the patient in turn uses the microphone which is also integrated into the multifunction display for this purpose. Likewise the medical personnel can talk to the patient in the same way at any time without having to move toward the patient in order to do so. In dialysis clinics, where there are several dialysis machines performing treatments on several patients simultaneously, this option makes it possible to greatly facilitate the work for the medical personnel.

Monolithic integration of electronic elements into the semiconducting layer of the display screen, implementing an inductive energy and data transmission system, for example, is also conceivable. Electromagnetic converters, for example, antennas or coils, may be used for this purpose. The electromagnetic converters may be equipped to convert electromagnetic waves into electrical signals and/or to convert electrical signals into electromagnetic waves. Consequently, they serve to allow input and output of data and/or information and/or energy. For example, data and/or energy can be transmitted by electromagnetic radiation to a device which held in proximity of the screen, said device being located in the vicinity of the display screen and being equipped to receive such energy and information transmitted electromechanically from a coil which is situated, for example, on the underside of the glass carrier of the display screen and a corresponding functional electronic system, which is monolithically integrated into the semiconducting layer on the glass carrier of the display screen,. Those skilled in the art are familiar with such systems from RFID technology. It is likewise conceivable for RFID-based data and/or energy to also be transmissible to the screen from a device held in the vicinity of the display screen by using the electronic system described here. By using a multifunction display designed in this way in conjunction with use in a dialysis machine, this also yields other advantages. The patient card already mentioned above is often designed in RFID technology. A multifunction display having the functionality of an inductive data and energy transmission can communicate with such a patient card in a known way. In addition to reading patient data and treatment data from the patient card, this also includes writing current treatment data onto the patient card during or after the dialysis treatment, such as the duration of dialysis or the quantity of water withdrawn by ultrafiltration or the occurrence of special events, for example, an increase in body temperature, which can in turn be detected by the same multifunction display, which may be designed so that pyrometric measurements may additionally be performed in the manner already described above.

Due to the use of multifunction displays in medical devices, in particular in dialysis machines, it is now possible for the first time to implement the functions described previously through a single module. All the functions can be assumed by a single module, the multifunction display with an appropriate design if a touchscreen, a camera (possibly also an infrared camera), a scanner, a fingerprint scanner, a loudspeaker and/or a microphone and means for RFID communication have been necessary for this so far. This has substantial advantages in assembly, maintenance, cost and cleanliness of the dialysis machine.

The structural sizes of integrated components on a semiconducting layer such as, for example, a CG-Si layer on the glass carrier of a display screen, which are possibly much smaller in comparison with conventional amorphous Si layers, permit the integration of complex and efficient electronic devices and systems. The applications of such highly integrated electronic systems are almost unlimited and rely on the possibilities of conventional micro-electronics, which are based on the monocrystalline silicon wafer technology. It will therefore be clear to those skilled in the art that the applications described here are only examples. It is essential that the applications of this technology in combination with medical products lead to new synergies.

The present invention is explained in greater detail below with reference to the accompanying figures on basis of exemplary embodiments. Identical reference numerals in the figures denote elements that are the same or have the same effect. They show:

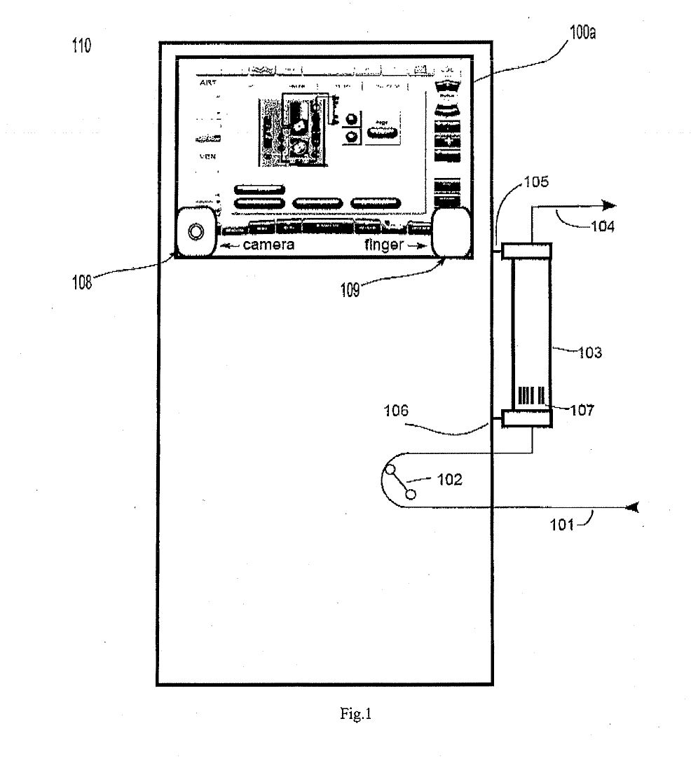

FIG. 1 shows a first inventive embodiment of a technical medical device having a display screen with a scanner and camera functionality.

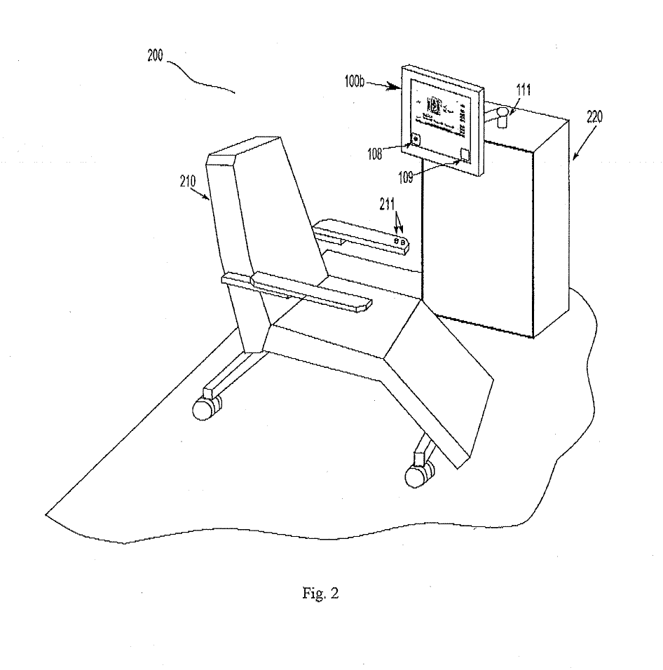

FIG. 2 shows a second inventive embodiment of a technical medical device having a movable display screen, which is embodied as a multifunction display screen, and a treatment chair.

FIG. 1 shows a first inventive embodiment of a technical medical device having a multifunction display with an additional scanner functionality. The technical medical device is designed here as a hemodialysis machine. It is clear to those skilled in the art that the invention can be applied to any technical medical device without restriction, in particular to blood treatment devices, for example, to machines for automatic peritoneal dialysis, for hemofiltration, for hemodiafiltration, for plasmapheresis or for similar procedures.

The hemodialysis machine 110 shows parts of an extracorporeal blood circulation with an arterial blood line 101, which carries the blood of a patient (not shown). The blood pump 102 conveys the blood through a dialysis filter 103, which is furnished with a semipermeable membrane separating the extracorporeal blood circulation from a dialysate circulation. The treated blood is returned to the patient through the venous line 104. Dialysate is pumped through the dialysate lines 105 and 106 and through the dialysis filter 103, where a diffuse mass exchange with the blood of the patient occurs through the semipermeable membrane of the dialysis filter 103. If a pressure gradient is also established from the blood side of the dialysis filter to the dialysate side of the patient, plasma water is expressed out of the blood and into the dialysate. The water content of the patient's blood may thus be reduced. The dialysate is prepared in the hemodialysis machine 110 and is discarded after use.

The display screen 100a in FIG. 1 is equipped as a multifunction display having additional phototransistors in the manner already described above. Objects held directly in front of the display screen can be detected in this way. As an example, a typical image content, which may occur during a dialysis treatment, is shown on the display screen 100.

The scanner functionality of the display screen 100 makes it possible, for example, to detect one or more finger touches to the display screen and to ascertain their position on the screen. The functionality of a touchscreen can be achieved without requiring the presence of a touch-sensitive layer, as is the case with a conventional touchscreen, in this way.

In addition, it is readily possible through the determination of position by image technology, to determine the positions of multiple fingers touching the screen simultaneously. Such a multitouch functionality can be implemented only with great complexity with conventional touchscreens, which are usually equipped with capacitive measurement methods. For example, the multitouch functionality may be used to span an interval of values, for example, on a value scale using two fingers, for example, to easily enter the upper and lower limits of a parameter. It is likewise conceivable to trigger an enlarged or reduced representation of the touchscreen display below the movement of the fingers by moving two fingers on the touchscreen.

The resolution of display screens for technical medical devices, which have a separate phototransistor for each pixel, is not usually sufficient to be able to enter fingerprints. The screen 100a is therefore furnished with a fingerprint sensor 109, in the area of which there are no liquid crystal cells and consequently there is also no image content. In this area, the resolution of the phototransistors or other light-sensitive sensors may be much greater than that in the remaining area of the screen.

The operating personnel, the attending physicians or patients can be recognized easily and conveniently by pressing a finger, for example, the thumb, on the fingerprint sensor 109 in this way. This allows identification of patients, and treatment parameters for this specific patient can be transferred in the manner described above.

The medical personnel can also be identified in this way. Therefore only known persons suitable for that purpose are allowed to initiate operating interventions. The properties (patient, physician, medical personnel) assigned to the individual known persons may be stored in the dialysis machine or at a remote location, for example, a central computer, connected to it for data transmission. Before entering operator data, the operator must thus first be identified by his fingerprint. This increases the security of the treatment.

In addition to detecting finger touch on the screen, barcode detection can also be implemented by using the scanner functionality of the display screen 100 from FIG. 1. The dialysis filter 103 is characterized unmistakably by a barcode 107 in FIG. 1. For example, this identification may include the exact type of dialysis filter. In the setting up the dialysis machine, the barcode of the set-up part can thus be held in front of the screen 100a, which is able to the barcode due to its scanner functionality. This may take place with a high resolution by means of the fingerprint sensor, but for input of barcodes, the resolution of the remaining screen is usually adequate if there is a separate phototransistor for each pixel.

Through appropriately stored databases, either in the dialysis machine itself or at a remote location (central computer) connected to the dialysis machine by a data link, the dialysis machine can unambiguously identify the set-up part and display this for the furnishing medical personnel on the display screen 100a and at the same time can verify whether the set-up part is suitable for the treatment.

If the set-up part is not suitable for the treatment, a warning can be issued to the medical personnel performing the set-up by optical and/or acoustic and/or haptic display. In addition, the dialysis machine may refuse to perform the treatment as long as suitable set-up parts for scanning are not presented to it. The dialysis machine can also verify whether all the required parts for the equipment are present and take suitable measures if too few of the set-up parts are available for the pending treatment in this way. The machine may therefore be instructed that, for example, a certain venous drip chamber has not yet been scanned in but is absolutely essential for the pending treatment. This increases the safety of the treatment.

The screen 100a from FIG. 1 is equipped with a camera device 108, which was already described above. The dialysis machine furnished in this way can now also recognize people or objects not located directly in front of the screen. It is conceivable for the area of the screen onto which the camera device projects an image to have a plurality of phototransistors having a greater resolution than the pixel resolution of the screen of the remaining screen surface. An adequate resolution of the camera device can be achieved in this way. It is also conceivable for the photo-transistors or other light-sensitive sensors in this area to be sensitive to infrared light and/or visible light.

Due to this embodiment of the screen, it is possible to recognize people or objects by their visual appearance alone. Set-up parts can thus be recognized on the basis of their projected image alone. Likewise the people involved in the dialysis treatment can be recognized by their image. For use in identifying people and objects, methods with which those skilled in the art for image recognition may also be used.

Another application is derived due to the design of the camera device 108, in which the sensors onto which an image is projected are sensitive for infrared radiation. Thus by detecting the infrared radiation of a patient, his body temperature can be determined and displayed pyrometrically. It is possible in this way to detect whether or not the patient has a fever or has hypothermia and to take appropriate measures. Thus, in the event the patient has a slight hypothermia, the dialysate temperature can be raised slightly, for example, to be able to achieve warming of the patient's blood via the mass exchange taking place in the dialysis filter between the blood and dialysate. Conversely, the dialysate temperature may be lowered if there is a slight elevation in the patient's body temperature. Treatment may also be denied if a marked fever is detected in the patient. It is conceivable that in this case the dialysis machine could disclose the presence of the fever in the current patient by way of existing communication means (reporting to an alarm system, central computer, beeper of the attending physician or outputting an optical and/or acoustic and/or haptic warning). This may also take place even during a treatment. To do so, the multifunction display having a camera function may advantageously be movably attached to the dialysis machine, as illustrated in FIG. 2. During the dialysis, which may last for several hours, entertainment content may be offered to the patient via the screen. At the same time, the camera implemented in the multifunction display can observe the patient and, for example, transmit the camera image, which can be monitored by the medical personnel, to a monitor at a distance. The medical personnel can stay informed about the visual impression given by the patient in this way without having to actually physically approach the patient. If the multifunction display is also equipped to detect infrared radiation from the patient, then the patient's body temperature can be determined easily and efficiently even during dialysis.

FIG. 2 shows a preferred embodiment of a technical medical device 220. A patient recliner device 210, shown in FIG. 2 as an adjustable patient chair, may be made available for the patient for safe and convenient positioning during a treatment. In this embodiment of the technical medical device, it is essential for the multifunction display 100b to be movably connected to the technical medical device 220 by the coupling device 111, which is adjustable in several directions and is merely indicated in FIG. 2. It is thus possible to align the multifunction display with the patient, who is sitting in the patient recliner device 210, so that the patient can observe the screen contents.

During a treatment, movies, for example, may be shown for the patient on the multifunction display for his entertainment. The multifunction display in FIG. 2 is designed so that it combines a display screen, loudspeaker, microphone and camera simultaneously in a module in the manner already described above. When designed in this way, a complete communication and entertainment system can be implemented with just a single module, namely the multifunction display. During his treatment, the patient can follow an entertainment film shown on the multifunction display 100b. The sound for this entertainment film may also be played back by the multifunction display 100b, namely in such a way that the multifunction display surface has corresponding actuators, which are controlled by an electronic system also integrated into the multifunction display. At the same time, a partial area of the multifunction display 100b may be designed as a microphone in a manner already described, so the patient can interact acoustically with a person at a remote site as needed. To this end, the patient can depress an operating switch 211 accordingly to activate the microphone functionality. Other operating switches 211 may control other functions, for example, the loudness of the multifunction display. In FIG. 2, the operating switches are installed in an armrest on the patient recliner device 210, for example. However, the task of these switches can also be taken over by a remote operation. An optional camera 108 can monitor the patient visually during the treatment by transmitting the patient image to a central monitoring station. The medical personnel can then get a visual impression of the patient at any time there without having to actually approach the patient.

In addition, monitoring of the patient's body temperature can be implemented by the camera 108 in the manner already described above. This information can also be transmitted to a central monitoring station and may optionally also trigger an alarm message there if the body temperature deviates too much from the normal body temperature.

With the help of this invention, it is possible to simplify the design of technical medical equipment, which is furnished with a display screen. Numerous functions, which were previously implemented as separate modules can now be combined into one single module. The functionality of the technical medical device may therefore increase while the costs of acquisition, installation and maintenance are reduced at the same time. The present invention is not limited to the embodiments described above; they serve only the purpose of illustration. It will be self-evident to those skilled in the art to use the features of this invention to design additional embodiments.

1. A technical medical device having a display screen,
characterized in that
the display screen has additional devices to convert electrical signals into mechanical movements or to convert mechanical movement into electrical signals.

2. The technical medical device having a display screen,
characterized in that
the display screen has additional devices to visually detect objects held in front of at least parts of its screen surface.

3. The technical medical device having a display screen,
characterized in that
the display screen has additional devices for sending or receiving electromagnetic signals.

4. The technical medical device according to claim 1,
characterized in that
the display screen is a liquid crystal display screen, and the display screen has a semiconducting layer into which electronic components for controlling the liquid crystal cells of the liquid crystal display screen are integrated, and additional electronic components, which may be embodied in such a way that they serve to control the additional devices, are integrated into the same semiconducting layer.

5. The technical medical device according to claim 4,
characterized in that
the additional electronic components are equipped for controlling electromechanical converters.

6. The technical medical device according to claim 4,
characterized in that
the additional electronic components are equipped for controlling optical sensors.

7. The technical medical device according to claim 4,
characterized in that
the additional electronic components are equipped for controlling electromagnetic converters.

8. The technical medical device according to claim 5,
characterized in that
the electromechanical converters are piezoelectric elements.

9. The technical medical device according to claim 8,
characterized in that
the piezoelectric elements are equipped as sound converters.

10. The technical medical device according to claim 8,
characterized in that
the piezoelectric elements are equipped as force sensors.

11. The technical medical device according to claim 6,
characterized in that
the optical sensors are sensitive to visible light and/or infrared light.

12. The technical medical device according to claim 6,
characterized in that
the optical sensors are equipped for scanning barcodes and/or fingerprints.

13. The technical medical device according to claim 6,
characterized in that
the optical sensors are equipped for detecting one or more finger positions on the screen surface.

14. The technical medical device according to claim 6,
characterized in that
the optical sensors form parts or a camera.

15. The technical medical device according to claim 6,
wherein the optical sensors or the camera is/are equipped to detect the surface temperature or body temperature of an object or a person.

16. The technical medical device according to claim 7,
characterized in that
the electromagnetic converters are equipped for sending or receiving RFID-based data and/or energy.

17. The technical medical device according to claim 1,
wherein
the technical medical device is a blood treatment device.

18. The technical medical device according to claim 17,
wherein
the blood treatment device is equipped for hemodialysis, hemofiltration, hemodiafiltration, plasmapheresis or automatic peritoneal dialysis.

19. A method for output and detection of information in a technical medical device,
characterized in that
single module is used for output and detection of optical, acoustic and/or electromagnetic signals.

20. The method according to claim 17,
wherein
the technical medical device is a blood treatment device.

21. The method according to claim 20,
wherein
the blood treatment device is equipped for hemodialysis, hemofiltration, hemodiafiltration, plasmapheresis or automatic peritoneal dialysis.

22. The method according to claim 19, wherein
the module is equipped to detect barcodes and wherein, on the basis of the detected barcodes, the objects thereby identified are recognized and the control of the technical medical device is influenced as a function thereof.

23. The method according to claim 19, wherein
the module is equipped to detect fingerprints and wherein the control of the technical medical device is influenced on the basis of the fingerprint thereby detected.

24. The method according to claim 19, wherein
the module is equipped to detect objects or persons and wherein the control of the technical medical device is influenced on the basis of the objects or persons thereby detected.

25. The method according to claim 19, wherein
the module is equipped to detect the surface temperature of objects or persons and wherein the control of the technical medical device is influenced on the basis of the surface temperature of the objects or persons thereby detected.

26. The method according to claim 19, wherein
the module is equipped to receive and/or send FRID-based signal and/or energy and thereby exchange information between the technical medical device and another device.

27. A device for performing the method claim 19.
